(19) United States
(12) Patent Application Publication
(10) Pub. No.: US 2009/0190976 A1
(43) Pub. Date: Jul. 30, 2009

(54) Automatic document feeder and method for duplex scanning a document utilizing the same

(76) Inventors: Chen-Tsai Tsai, Taipei (TW); Keng-Wei Shih, Taipei (TW); Hsueh-chou Hsu, Taipei (TW); Tien-Ho Hsu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/081,958

(22) Filed: Apr. 24, 2008

(30) Foreign Application Priority Data
Jan. 25, 2008 (CN) 200810006021.9

(51) Int. Cl. G03G 15/00; B65H 29/58

(52) U.S. Cl. 399/361; 271/225

(57) ABSTRACT

An automatic document feeder includes a first path extending from a feeding tray to a scanning module, a second path extending from the scanning module to a reversing roller unit, and a third path extending from the reversing roller unit to an intermediate portion of the first path. A document is moved from the feeding tray onto the reversing roller unit via the first and second paths for a first scanning. Just before the document is moved through the second path, the reversing roller unit is driven to allow the document to move therethrough. Subsequently, the document is reversed on the reversing roller unit to move through a looped passage defined by the third path, a portion of the first path downstream of the intermediate portion, and the second path for a second scanning. The reversing roller unit is operable to allow two opposite edges of the document to move thereon in different directions.

### CROSS-REFERENCE TO RELATED APPLICATION

This application claims priority of China Application No. 200810006021.9, filed on Jan. 25, 2008.

### BACKGROUND OF THE INVENTION

1. Field of the Invention

This invention relates to an automatic document feeder, and more particularly to an automatic document feeder applicable to a copy machine and a method for duplex scanning a document utilizing the same.

2. Description of the Related Art

Referring to FIGS. 1 and 2, in one embodiment of a conventional duplex scanning method disclosed in U.S. Pat. No. 6,307,614, to scan a second side surface of a document 900 in an automatic document feeder 9, upper and lower delivery rollers 91, 92 are rotated clockwise and counterclockwise, respectively, as shown in FIG. 1, to move the document 900 around a wrap roller 93. When a leading edge of the document 900 comes into contact with the upper and lower delivery rollers 91, 92, sheet buckle is caused. To eliminate such sheet buckle, the rotational direction of each of the upper and lower delivery rollers 91, 92 is reversed, as shown in FIG. 2 to allow the leading edge of the document 900 to be grabbed between a nip defined between the upper and lower delivery rollers 91, 92. Subsequently, the rotational direction of the upper delivery roller 91 is again reversed to allow the leading and trailing edges of the document 900 to move in different directions. With such a configuration, the footprint size of the automatic document feeder 9 can be reduced. However, such formation and elimination of sheet buckle not only increase the second scanning time, but also affect adversely the scanning quality of the document 900.

Referring to FIG. 3, in another embodiment disclosed in U.S. Pat. No. 6,307,614, to move the leading and trailing edges of the document 900 in different directions in an automatic document feeder 9′, a pinch roller 91′ can be separated from a driven roller 92′ through operation of an elevating mechanism (not shown). However, the structure of the feeder 9′ is complex due to the presence of the elevating mechanism. This increases the manufacturing costs of the feeder 9′.

### SUMMARY OF THE INVENTION

An object of this invention is to provide a method for duplex scanning a document that is efficient and that can maintain a good scanning quality of the document.

Another object of this invention is to provide an automatic document feeder that has a simple structure.

According to an aspect of this invention, there is provided a method for duplex scanning a document, the document having opposite first and second edges, the method comprising the steps of:

(A) moving a document from a feeding tray to a scanning module along a first path;

(B) moving the document through the scanning module for a first-side scanning;

(C) driving one of two reversing rollers to rotate in a forward direction to thereby move the document along a second path into a nip defined by the reversing rollers such that the first edge of the document passes through the nip in an ejecting direction;

(D) driving the one of the reversing rollers to rotate in a reverse direction opposite to the forward direction to thereby move the second edge of the document from the reversing rollers onto the first path along a third path in a feeding direction opposite to the ejecting direction in response to separation of the second edge of the document from the second path;

(E) driving the one of the reversing rollers to rotate in the forward direction to thereby move the second edge of the document into the nip through the scanning module and the second path to permit the first and second edges of the document to be disposed between the reversing rollers such that the first and second edges of the document are in slidable contact with each other; and

(F) moving the first edge of the document through the scanning module and the second path to complete a second-side scanning.

Since no sheet buckle causing and eliminating steps are included in the method, the time required for performing the method can be reduced significantly.

According to another aspect of this invention, there is provided an automatic document feeder adapted for use on an image formation device, the image formation device including a scanning module, the automatic document feeder comprising:

a feeding tray adapted for receiving a document to be scanned;

an ejecting tray;

a first path adapted to extend from the feeding tray to the scanning module and adapted for guiding the document to move from the feeding tray toward the scanning module;

a separating/feeding roller unit adapted for moving the document from the feeding tray onto the first path;

a reversing roller unit disposed in proximity to the ejecting tray, the reversing roller unit including a pair of upper and lower reversing rollers and adapted to move the document between the upper and lower reversing rollers in a selected one of an ejecting direction and a feeding direction that are opposite to each other;

a second path adapted to extend from the scanning module to the reversing roller unit and adapted for guiding the document to move from the scanning module onto the reversing roller unit;

a third path extending from the reversing roller unit to the first path and having an end in spatial communication with the second path, the third path being adapted for guiding the document to move from the reversing roller unit onto the first path in the feeding direction;

a control unit for driving at least one of the upper and lower reversing rollers to rotate in a selected one of two directions; and

a first sensor adapted for detecting the position of the document and transmitting a signal to the control unit so that the control unit controls the rotation and rotational direction of the one of the upper and lower reversing rollers upon receiving the signal.

In the automatic document feeder, it is not necessary to provide an elevating mechanism for separating the upper and lower reversing rollers, thereby resulting in a simple structure.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a schematic side view of one embodiment of an automatic document feeder disclosed in U.S. Pat. No. 6,307,614, illustrating formation of sheet buckle;

FIG. 2 is a view similar to FIG. 1 but illustrating elimination of the sheet buckle;

FIG. 3 is a schematic side view of another embodiment of an automatic document feeder disclosed in U.S. Pat. No. 6,307,614;

FIG. 4 is a schematic side view of the preferred embodiment of an automatic document feeder according to this invention in a state of use on an image formation device;

FIG. 5 is a schematic block diagram of the preferred embodiment;

FIG. 6 is a schematic side view of the preferred embodiment, illustrating how a document is moved from a feeding tray onto a reversing roller unit through a first path, a scanning module, and a second path;

FIG. 7 is a view similar to FIG. 6 but illustrating how the rotational direction of a lower reversing roller of the reversing roller unit is reversed in response to separation of the document from the second path;

FIG. 8 is a view similar to FIG. 6 but illustrating how the lower reversing roller is driven to rotate in a forward direction when a first sensor detects the presence of a leading edge of the document;

FIG. 9 is a view similar to FIG. 6 but illustrating a state in which the leading edge of the document reaches an end of the second path proximate to the reversing roller unit during a second scanning operation;

FIG. 10 is a view similar to FIG. 6 but illustrating a state in which the leading edge of the document is moved through the reversing roller unit in an ejection direction such that the document extends through a looped passage during the second scanning operation; and

FIG. 11 is a view similar to FIG. 6 but illustrating a state in which a trailing edge of the document is moved out of the reversing roller unit during the second scanning operation.

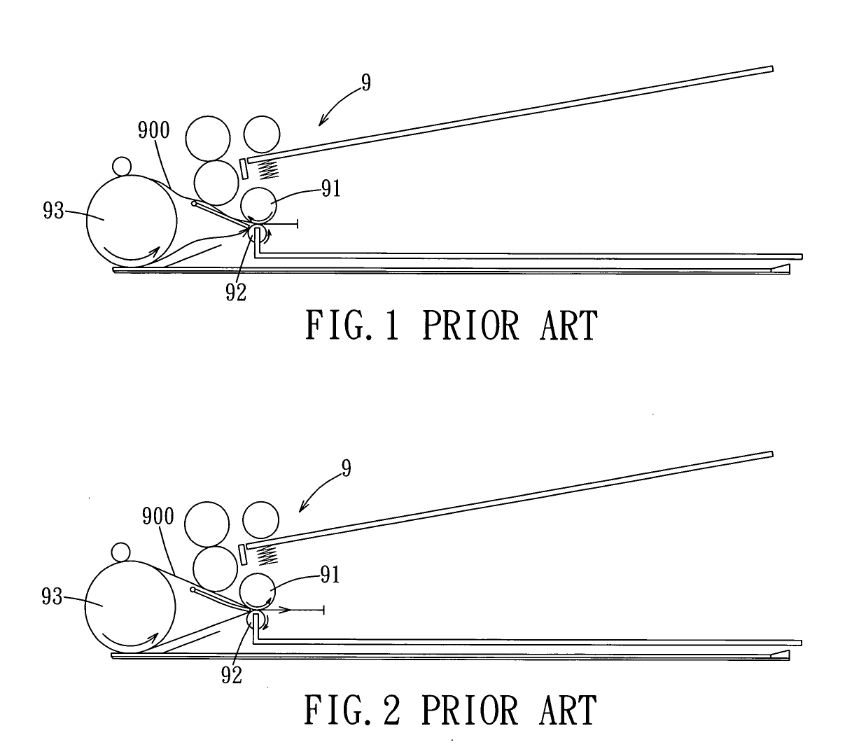

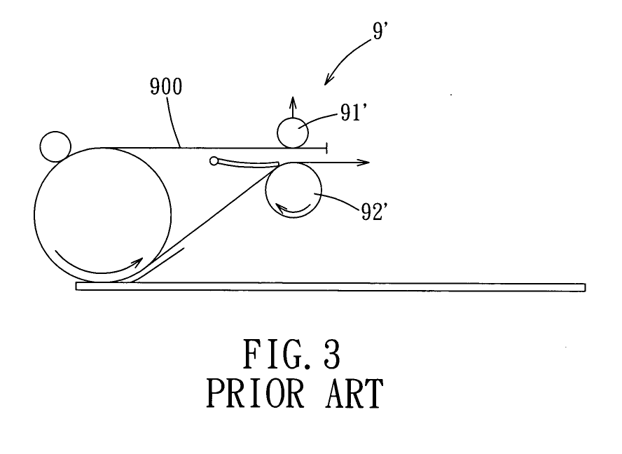

### DETAILED DESCRIPTION OF THE PREFERRED EMBODIMENT

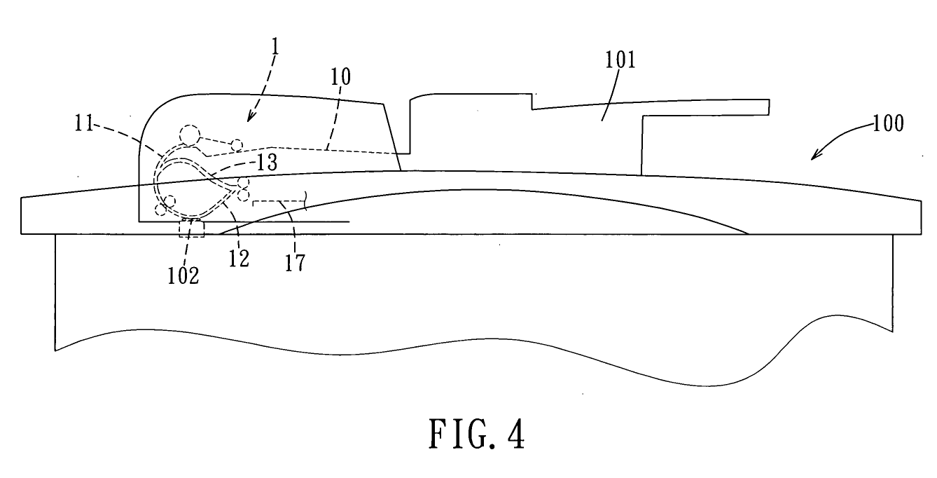

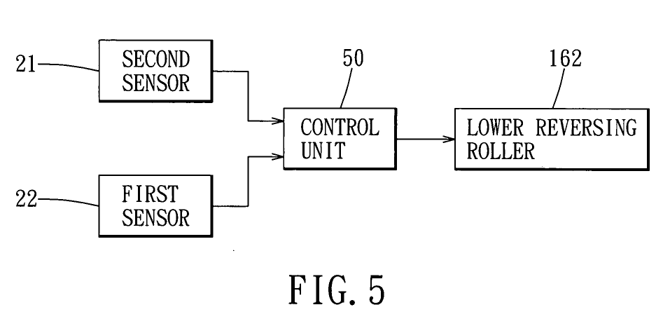

Referring to FIGS. 4 to 6, the preferred embodiment of an automatic document feeder 1 according to this invention is disposed on a top cover 101 of an image formation device 100, such as a copy machine. The image formation device 100 includes a scanning module 102 disposed under the top cover 101.

The automatic document feeder 1 includes a feeding tray 10, a first path 11, a second path 12, a third path 13, a separating/feeding roller unit 14, a guide roller unit 15, a reversing roller unit 16, and an ejecting tray 17. The feeding tray 10 is disposed on the top cover 101 for receiving a document 200 to be scanned. The first path 11 extends from the feeding tray 10 to the scanning module 102 for guiding the document 200 from the feeding tray 10 toward the scanning module 200. The separating/feeding roller unit 14 is disposed between the feeding tray 10 and the first path 11 for moving the document 100 from the feeding tray 10 onto the first path 11. The guide roller unit 15 is disposed along the first path 11. The ejecting tray 17 is disposed on the top cover 101. The reversing roller unit 16 is disposed in proximity to the ejecting tray 17, and includes a pair of upper and lower reversing rollers 161, 162. The lower reversing roller 162 is rotatable to move the document 200 between the upper and lower reversing rollers 161, 162 in a selected one of an ejecting direction 301 and a feeding direction 302 that are opposite to each other. The second path 12 extends from the scanning module 102 to the reversing roller unit 16 for guiding the document 200 to move from the scanning module 102 onto the reversing roller unit 16. The third path 13 extends from the reversing roller unit 16 to an intermediate portion 110 of the first path 11 for guiding the document 200 to move out of the reversing roller unit 16 in the feeding direction 302. The third path 13 has an end in spatial communication with the second path 12 at a position adjacent to the reversing roller unit 16.

The automatic document feeder 1 further includes a first sensor 22, a second sensor 21, and a control unit 50. The first sensor 22 is disposed along the first path 11 and in proximity to the scanning module 102. The second sensor 21 is disposed at a junction between the second and third paths 12, 13. The lower reversing roller 162 is driven to rotate in a forward direction (i.e., clockwise direction) or a reverse direction (i.e., counterclockwise direction).

A method for duplex scanning the document 200 according to this invention includes the following steps:

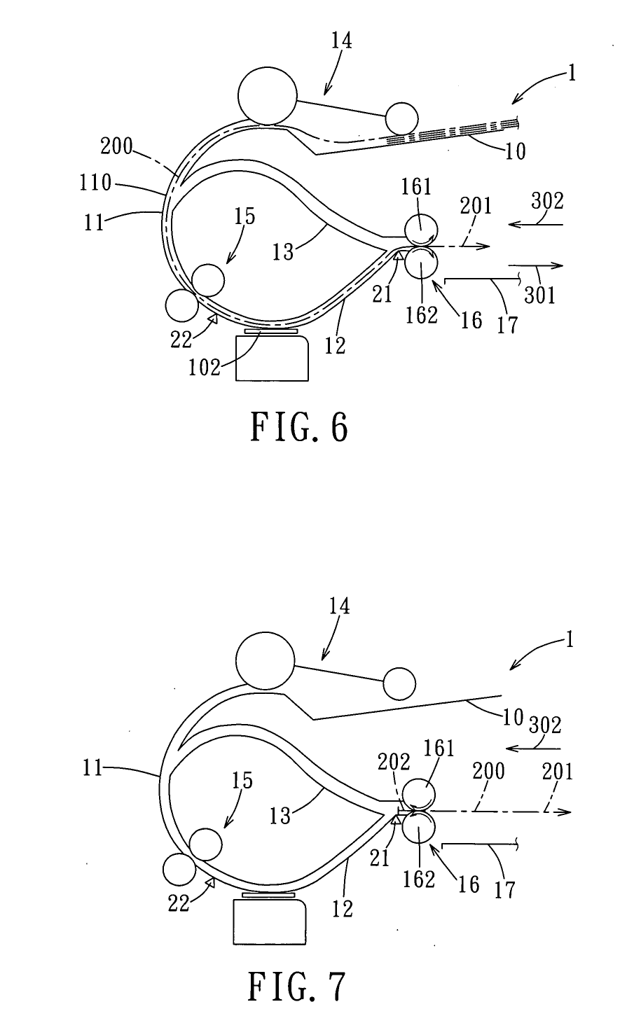

(A) The document 200 is moved from the feeding tray 10 to the scanning module 102 along the first path 11 by the separating/feeding roller unit 14. During movement of the document 200 along the first path 11, when the first sensor 22 detects the presence of a first edge 201 (i.e., the leading edge) of the document 200, it emits a signal to the control unit 50. The control unit 50 drives the lower reversing roller 162 to rotate clockwise (i.e., in the forward direction) upon receiving the signal from the first sensor 22. Hence, the upper reversing roller 161 is driven by the lower reversing roller 162 due to friction contact therebetween, as shown in FIG. 6.

(B) The document 200 is guided by the guide roller unit 15 to move through the scanning module 102 for a first scanning (i.e., first-side scanning).

(C) The document 200 is moved along the second path 12 into a nip defined by the upper and lower reversing rollers 161, 162 such that the first edge 201 of the document 200 is moved through the nip in the ejecting direction 301 by the upper and lower reversing rollers 161, 162, as shown in FIG. 6.

(D) When the document 200 is separated from the second path 12, as shown in FIG. 7, so that the second sensor 21 detects the presence of a second edge 202 (i.e., the trailing edge) of the document 200, the second sensor 21 emits a signal to the control unit 50. When the control unit 50 receives the signal from the second sensor 21, it drives the lower reversing roller 162 to rotate counterclockwise (i.e., in the reverse direction), as shown in FIG. 7. Hence, the second edge 202 of the document 200 is moved from the upper and lower reversing rollers 161, 162 onto the first path 11 along the third path 13 in the feeding direction 302.

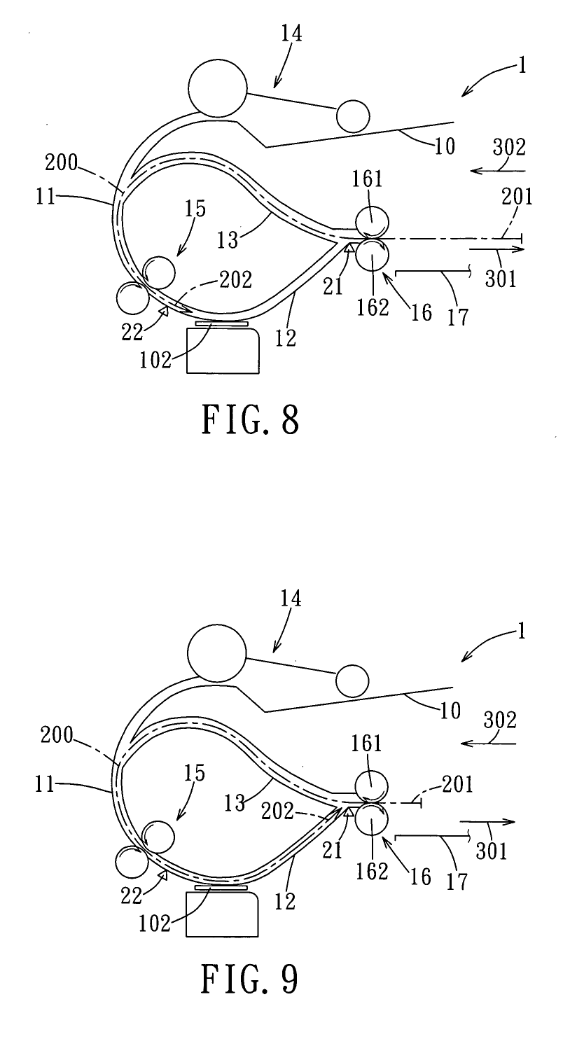

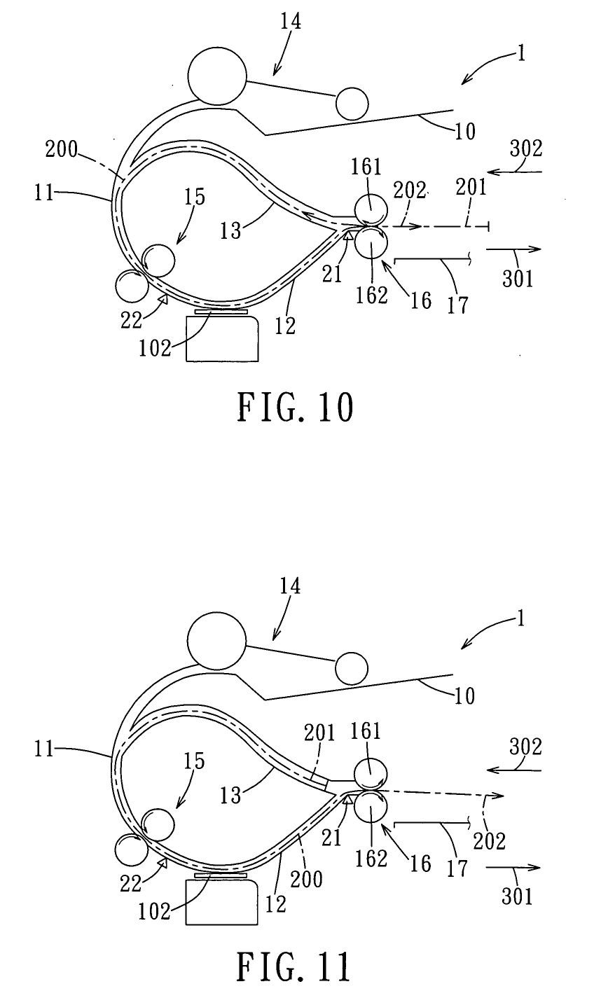

(E) When the second edge 202 of the document 200 reaches the position shown in FIG. 8, the lower reversing roller 162 is rotated clockwise through detection of the first sensor 22 and under the control of the control unit 50 in the above manner. At this time, the upper reversing roller 161 also rotates clockwise due to frictional contact with the running document 200. Because of clockwise rotation of the lower reversing roller 162, after the second edge 202 of the document 200 reaches an end of the second path 12 proximate to the reversing roller unit 16, as shown in FIG. 9, continued advancement of the document 200 results in movement of the second edge 202 of the document 200 into the nip to allow the first and second edges 201, 202 of the document 200 to be disposed between the upper and lower reversing rollers 161, 162 such that the first and second edges 201, 202 are in slidable contact with each other. As such, the upper and lower reversing rollers 161, 162 rotate in different directions, and the first and second edges 201, 202 of the document 200 move on the reversing roller unit 16 in different directions, as shown in FIG. 10. The outer surfaces of the upper and lower reversing rollers 161, 162 are designed so that friction between the lower reversing roller 162 and the document 200 is larger than that between the upper reversing roller 161 and the document 200, thereby enabling the first and second edges 201, 202 of the document 200 to move between the upper and lower reversing rollers 161, 162 in different directions at this time. Subsequently, when the first edge 201 of the document 200 is moved out of the reversing roller unit 16 in the feeding direction 302, the upper reversing roller 161 is driven by the lower reversing roller 162 to rotate counterclockwise, as shown in FIG. 11. Thus, the document 200 can be moved along a looped passage defined by the third path 13, a portion of the first path 11 downstream of the intermediate portion 110, and the second path 12.

(F) The document 200 is driven by the upper and lower reversing rollers 161, 162 to move in the ejecting direction 301. Hence, the first edge 201 of the document 200 is moved through the scanning module 102 and the second path 12 to complete a second scanning (i.e., second-side scanning).

After the step (F) is performed, to invert the document 200, the steps (D) and (E) are repeated but the leading and trailing edges of the document 200 are interchanged as the first and second edges 201, 202, respectively. As a result of the second movement of the document 200 along the looped passage, the document 200 is moved out of the upper and lower reversing rollers 161, 162 in the ejecting direction 301, and thus drops onto the ejecting tray 17.

In an alternative embodiment, the control unit 50 is operable to drive the upper and lower reversing rollers 161, 162 to rotate.

In another alternative embodiment, the second sensor 21 is omitted. In this embodiment, when the first sensor 22 detects the presence of the trailing edge of the document 200, it emits a corresponding signal to the control unit 50. The control unit 50 drives the lower reversing roller 162 to rotate counterclockwise after a predetermined time interval from when it receives the corresponding signal. The time interval is selected so that the trailing edge of the document 200 separates from the second path 12 just before the lower reversing roller 162 is driven to rotate counterclockwise.

Since no sheet buckle causing and eliminating steps of the above-mentioned conventional duplex scanning method are included in the method of this invention, the time required for performing the method of this invention can be reduced significantly.

Furthermore, in the automatic document feeder of this invention, the first and second edges 201, 202 of the document 200 are moved on the reversing roller unit 16 in different directions through control of the rotational directions of the upper and lower reversing rollers 161, 162. As a result, it is not necessary to provide an elevating mechanism for separating the upper and lower reversing rollers 161, 162, thereby resulting in a simple structure.

With this invention thus explained, it is apparent that numerous modifications and variations can be made without departing from the scope and spirit of this invention. It is therefore intended that this invention be limited only as indicated by the appended claims.

I claim:

1. A method for duplex scanning a document, the document having opposite first and second edges, said method comprising the steps of:
(A) moving a document from a feeding tray to a scanning module along a first path;
(B) moving the document through the scanning module for a first-side scanning;
(C) driving one of two reversing rollers to rotate in a forward direction to thereby move the document along a second path into a nip defined by the reversing rollers such that the first edge of the document passes through the nip in an ejecting direction;
(D) driving the one of the reversing rollers to rotate in a reverse direction opposite to the forward direction to thereby move the second edge of the document from the reversing rollers onto the first path along a third path in a feeding direction opposite to the ejecting direction in response to separation of the second edge of the document from the second path;
(E) driving the one of the reversing rollers to rotate in the forward direction to thereby move the second edge of the document into the nip through the scanning module and the second path to permit the first and second edges of the document to be disposed between the reversing rollers such that the first and second edges of the document are in slidable contact with each other; and
(F) moving the first edge of the document through the scanning module and the second path to complete a second-side scanning.

2. The method as claimed in claim 1, after said step (F), further comprising:
(G) driving the one of the reversing rollers to rotate in the reverse direction to move the first edge of the document from the reversing rollers onto the first path along the third path in response to separation of the first edge of the document from the second path; and
(H) driving the one of the reversing rollers to rotate in the forward direction to move the first edge of the document into the nip through the second path to permit the first and second edges of the document to be disposed between the reversing rollers such that the first and second edges of the document are in slidable contact with each other, continued rotation of the one of the reversing rollers in the forward direction resulting in movement of the second edge of the document through the second path and the nip so that the document is moved from the reversing rollers onto an ejecting tray.

3. The method as claimed in claim 2, wherein, in said steps (C) and (H), the first edge of the document is moved into the nip by driving the one of the reversing rollers to rotate in the forward direction just before the document is moved into the nip, and in said step (E), the second edge of the document is moved into the nip by driving the one of the reversing rollers to rotate in the forward direction just before the document is moved into the nip.

4. The method as claimed in claim 3, wherein, in said steps (C) and (H), the one of the reversing rollers is driven to rotate in the forward direction through detection of the presence of the first edge of the document by a first sensor disposed in proximity to the scanning module, and in said step (E), the one of the reversing rollers is driven to rotate in the forward direction through detection of the presence of the second edge of the document by the first sensor.

5. The method as claimed in claim 4, wherein, in said step (D), the one of the reversing rollers is driven to rotate in the reverse direction through detection of separation of the second edge of the document from the second path by a second sensor disposed at a junction between the second and third paths, and in said step (G), the one of the reversing rollers is driven to rotate in the reverse direction through detection of separation of the first edge of the document from the second path by the second sensor.

6. An automatic document feeder adapted for use on an image formation device, the image formation device including a scanning module, said automatic document feeder comprising:
a feeding tray adapted for receiving a document to be scanned;
an ejecting tray;
a first path adapted to extend from said feeding tray to the scanning module and adapted for guiding the document to move from said feeding tray toward the scanning module;
a separating/feeding roller unit adapted for moving the document from said feeding tray onto said first path;
a reversing roller unit disposed in proximity to said ejecting tray, said reversing roller unit including a pair of upper and lower reversing rollers and adapted to move the document between said upper and lower reversing rollers in a selected one of an ejecting direction and a feeding direction that are opposite to each other;
a second path adapted to extend from the scanning module to said reversing roller unit and adapted for guiding the document to move from the scanning module onto said reversing roller unit;
a third path extending from said reversing roller unit to said first path and having an end in spatial communication with said second path, said third path being adapted for guiding the document to move from said reversing roller unit onto said first path in the feeding direction;
a control unit for driving at least one of said upper and lower reversing rollers to rotate in a selected one of two directions; and
a first sensor adapted for detecting the position of the document and transmitting a signal to said control unit so that said control unit controls the rotation and rotational direction of the one of the upper and lower reversing rollers upon receiving the signal.

7. The automatic document feeder as claimed in claim 6, wherein said control unit is operable to drive said upper and lower reversing rollers to rotate.

8. The automatic document feeder as claimed in claim 6, wherein said first sensor is adapted to be disposed along said first path and in proximity to the scanning module.

9. The automatic document feeder as claimed in claim 6, further comprising a second sensor disposed at a junction between said second and third paths and adapted for detecting separation of the document from an end of said second path and transmitting a signal to said control unit so that said control unit activates said reversing roller unit to move the document on said reversing roller unit in the feeding direction.
